(19) United States
(12) Patent Application Publication
(10) Pub. No.: US 2025/0216682 A1
(43) Pub. Date: Jul. 3, 2025

(54) Electronic Device With Stray Light Redirection Structures

(71) Applicant: Apple Inc., Cupertino, CA (US)

(72) Inventors: Ofir Garcia Salazar, Cupertino, CA (US); Matthew D Suski, Sunnyvale, CA (US); Yu Song, San Jose, CA (US); Caroline Yu, Cupertino, CA (US)

(21) Appl. No.: 18/955,021

(22) Filed: Nov. 21, 2024

Related U.S. Application Data
(60) Provisional application No. 63/617,326, filed on Jan. 3, 2024.

(51) Int. Cl. G02B 27/01

(52) U.S. Cl. CPC G02B 27/0172; G02B 2027/0118

(57) ABSTRACT

An electronic device such as a head-mounted device may have a transparent layer supported by head-mounted support structures. A light source may emit light through the transparent layer, and an optical sensor may detect light that has reflected from an external object, such as to track the external object. A stray light redirecting structure may be formed in the transparent layer. The stray light redirecting structure may be configured to block stray light that is reflecting within the transparent layer. This reduces the amount of stray light received by the optical sensor. The stray light redirecting structure may formed from protrusions, recesses, gaps in the transparent layer, textured regions, micro-bubbles, and/or index-matched coatings. An opaque masking layer may be coupled to the transparent layer to absorb the stray light and further reduce the amount of stray light that reaches the optical sensor.

This application claims the benefit of U.S. provisional patent application No. 63/617,326, filed Jan. 3, 2024, which is hereby incorporated by reference herein in its entirety.

### FIELD

This relates generally to electronic devices, including electronic devices with optical sensors.

### BACKGROUND

Electronic devices may include optical sensors. For example, the optical sensors may detect light that has been emitted by a light source.

### SUMMARY

An electronic device such as a head-mounted device may have a transparent layer supported by head-mounted support structures. The transparent layer may cover the front of a head-mounted device and may overlap eye boxes where a user's eyes receive images from a display in the electronic device. Sensors may be used to make measurements of the environment surrounding a user of the head-mounted device. In some configurations, displayed images may be overlaid on top of real-world images. Transparent layer may also be incorporated into handheld devices and other equipment.

A transparent member for a head-mounted device or other equipment may be formed from a layer of polymer or other material. A light source may emit light through the transparent layer, and an optical sensor may detect light that has reflected from an external object, such as to track the external object. For example, the light source may be an infrared light source, and the optical sensor may be an infrared camera.

A stray light redirecting structure may be formed in the transparent layer. The stray light redirecting structure may be configured to redirect stray light that is reflecting within the transparent layer. For example, the stray light redirecting structure may defeat the total internal reflection of the stray light within the transparent structure. This reduces the amount of stray light received by the optical sensor. The stray light redirecting structure may formed from protrusions, recesses, gaps in the transparent layer, textured regions, micro-bubbles, and/or index-matched coatings.

An opaque masking layer may be coupled to the transparent layer to absorb the stray light and further reduce the amount of stray light that reaches the optical sensor.

### BRIEF DESCRIPTION OF THE DRAWINGS

FIG. 1 is a schematic diagram of an illustrative electronic device in accordance with some embodiments.

FIG. 2 is a top view of an illustrative electronic device in accordance with some embodiments.

FIG. 3 is a front view of an illustrative electronic device in accordance with some embodiments.

FIG. 4 is a side view of an illustrative electronic device having a transparent layer with a stray light redirecting structure formed from a recess in accordance with some embodiments.

FIG. 5 is a side view of an illustrative transparent layer having a stray light redirecting structure formed from a recess with dimensions that are proportional to a thickness of the transparent member in accordance with some embodiments.

FIG. 6 is a side view of an illustrative transparent layer with a stray light redirecting structure formed from a protrusion in accordance with some embodiments.

FIG. 7 is a side view of an illustrative transparent layer with a stray light redirecting structure formed from a gap between transparent structures in accordance with some embodiments.

FIG. 8 is a side view of an illustrative transparent layer with a stray light redirecting structure formed from a textured region in accordance with some embodiments.

FIG. 9 is a side view of an illustrative transparent layer with a stray light redirecting structure formed from micro-bubbles in accordance with some embodiments.

FIG. 10 is a side view of an illustrative transparent layer with a stray light redirecting structure formed from a coating that has a refractive index that matches a refractive index of the transparent layer in accordance with some embodiments.

FIG. 11 is a side view of an illustrative transparent layer with a stray light redirecting structure formed from a recess that overlaps a light source window in accordance with some embodiments.

FIG. 12 is a side view of an illustrative transparent layer with a stray light redirecting structure formed from a protrusion that overlaps a light source window in accordance with some embodiments.

### DETAILED DESCRIPTION

An electronic device may have a transparent member such as a transparent cover layer of glass or polymer in a pair of goggles, glasses, or other head-mounted device. The transparent member may be formed from a layer of polymer, a glass layer, and/or other layers of material. The electronic device may include at least one light source and one optical sensor. To reduce stray light interference, the transparent layer may include a stray light redirecting structure between the light source and the optical sensor. For example, the stray light redirecting structure may partially or entirely surround a window in the transparent layer through which the light source emits light. An opaque masking layer may be included on the stray light redirecting structure.

The stray light redirecting structure may reduce light from propagating within the transparent member from the light source to the optical sensor. The stray light redirecting structure may be formed from an isolated window, a protrusion, a textured region, micro-bubbles, an absorbing index-matched inner layer on the transparent member, or a recess, as examples. In general, the stray light redirecting structure may be formed from any suitable structure that defeats total internal reflection within the transparent member.

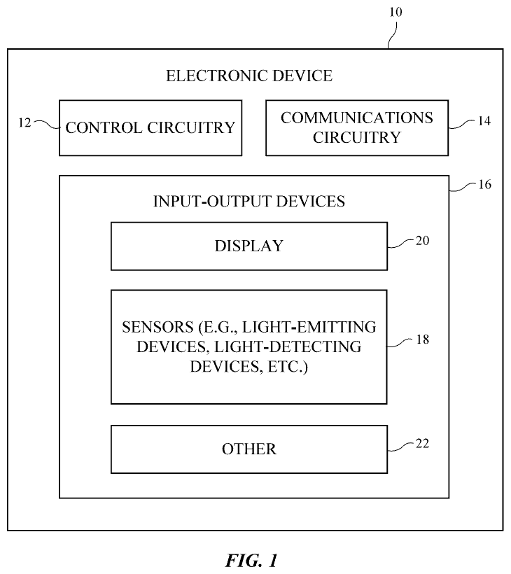

An illustrative electronic device of the type that may include a transparent member with stray light redirecting structures is shown in FIG. 1. As shown in FIG. 1, device 10 may include control circuitry 12, communications circuitry 14, and input-output devices 16. Device 10 may be a laptop computer, a computer monitor containing an embedded computer, a tablet computer, a desktop computer, a cellular telephone, a media player, or other handheld or portable electronic device, a smaller device such as a wristwatch device, a pendant device, a headphone or earpiece device, a head-mounted device such as glasses, goggles, a helmet, or other equipment worn on a user's head, or other wearable or miniature device, a television, a computer display that does not contain an embedded computer, a gaming device, a navigation device, an embedded system such as a system in which equipment is mounted in a kiosk, in an automobile, airplane, or other vehicle, a removable external case for electronic equipment, an accessory such as a remote control, computer mouse, track pad, wireless or wired keyboard, or other accessory, and/or equipment that implements the functionality of two or more of these devices.

Control circuitry 12 may include storage and processing circuitry for supporting the operation of device 10. The storage and processing circuitry may include storage such as nonvolatile memory (e.g., flash memory or other electrically-programmable-read-only memory configured to form a solid-state drive), volatile memory (e.g., static or dynamic random-access-memory), etc. Processing circuitry in control circuitry 12 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc.

To support communications between device 10 and external electronic equipment, control circuitry 12 may communicate using communications circuitry 14. Communications circuitry 14 may include antennas, radio-frequency transceiver circuitry, and other wireless communications circuitry and/or wired communications circuitry. Circuitry 14, which may sometimes be referred to as control circuitry and/or control and communications circuitry, may, for example, support wireless communications using wireless local area network links, near-field communications links, cellular telephone links, millimeter wave links, and/or other wireless communications paths.

Input-output devices 16 may be used in gathering user input, in gathering information on the environment surrounding the user, and/or in providing a user with output. Devices 16 may include sensors 18. Sensors 18 may include force sensors (e.g., strain gauges, capacitive force sensors, resistive force sensors, etc.), audio sensors such as microphones, capacitive touch sensors, capacitive proximity sensors, other touch sensors, ultrasonic sensors, sensors for detecting position, orientation, and/or motion (e.g., accelerometers, magnetic sensors such as compass sensors, gyroscopes, and/or inertial measurement units that contain some or all of these sensors), muscle activity sensors (EMG), radio-frequency sensors (e.g., radar and other ranging and positioning sensors), humidity sensors, moisture sensors, and/or other sensors.

Input-output devices 16 may include light sources such as light-emitting diodes (e.g., for camera flash or other blanket illumination, etc.), lasers such as vertical cavity surface emitting lasers and other laser diodes, laser components that emit multiple parallel laser beams (e.g., for three-dimensional sensing), lamps, and optical sensors such as photodetectors and digital image sensors. For example, sensors 18 in devices 16 may include depth sensors (e.g., structured light sensors and/or depth sensors based on stereo imaging devices that can optically sense three-dimensional shapes), optical sensors such as self-mixing sensors and light detection and ranging (lidar) sensors that gather time-of-flight measurements and/or other measurements to determine distance between the sensor and an external object and/or that can determine relative velocity, monochromatic and/or color ambient light sensors that can measure ambient light levels, proximity sensors based on light (e.g., optical proximity sensors that include light sources such as infrared light-emitting diodes and/or lasers and corresponding light detectors such as infrared photodetectors that can detect when external objects are within a predetermined distance), optical sensors such as visual odometry sensors that gather position and/or orientation information using images gathered with digital image sensors in cameras, gaze tracking sensors, visible light and/or infrared cameras having digital image sensors configured to gather image data, optical sensors for measuring ultraviolet light, and/or other optical sensor components (e.g., light sensitive devices and, if desired, light source), and/or other optical components (one or more light-emitting devices, one or more light-detecting devices, etc.).

Input-output devices 16 may also include displays such as display 20. Displays in device 10 may be organic light-emitting diode displays, displays based on arrays of light-emitting diodes formed from crystalline semiconductor dies, liquid crystal displays, electrophoretic displays, microelectromechanical systems (MEMs) displays such as displays with arrays of moving mirrors, liquid-crystal-on-silicon displays, and/or other displays.

If desired, input-output devices 16 may include other devices 22. Devices 22 may include components such as status indicator lights (e.g., light-emitting devices such as light-emitting diodes in devices 10 that serve as power indicators), and other light-based output devices, speakers and other audio output devices, electromagnets, permanent magnets, structures formed from magnetic material (e.g., iron bars or other ferromagnetic members that are attracted to magnets such as electromagnets and/or permanent magnets), batteries, etc. Devices 22 may also include power transmitting and/or receiving circuits configured to transmit and/or receive wired and/or wireless power signals. Devices 22 may include buttons, rotating buttons, push buttons, joysticks, keys such as alphanumeric keys in a keyboard or keypad, microphones for gathering voice commands, touch sensor input devices, accelerometers for gathering user input gestures such as tap gestures, and/or other devices for gathering user input. Devices 22 may also include output components such as haptic output devices and other output components.

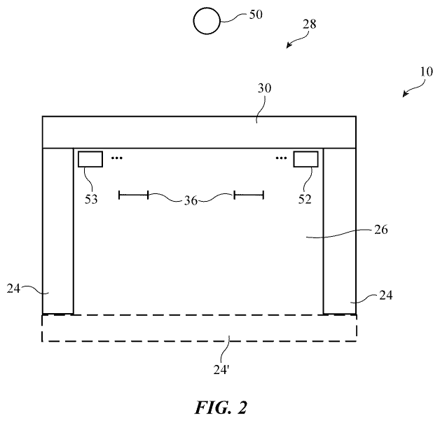

In an illustrative arrangement, which may sometimes be described herein as an example, device 10 may be a head-mounted device. Consider, as an example, the arrangement of FIG. 2. As shown in FIG. 2, device 10 may have housing structures such as housing 24. Housing 24 may be formed from materials such as polymer, glass, metal, ceramic, fabric, wood, other materials, and/or combinations of these materials. Housing 24 may be used to support structures such as transparent layer 30 that separate interior region (interior) 26 from exterior region (exterior) 28. In some configurations, housing 24 may have portions such as portion 24′ that help enclose some or all of interior 26 and separate interior 26 from exterior 28 (e.g., when housing 24 forms portions of the body of a vehicle or forms an enclosure for a cellular telephone or computer). In these arrangements, printed circuits, integrated circuits, mechanical structures, and other components (see, e.g., control circuitry 12, communications circuitry 14 and/or input-output devices 16) may be located within the enclosure formed by housing 24. Components such as these may also be coupled to housing 24 via a cable (as an example). In some arrangements, components for device 10 may be embedded within hollow portions of housing 24.

If desired, housing 24 of FIG. 2 may be configured to form head-mounted support structures that hold device 10 on a head of a user (with or without a rear strap, headband, or other rear portion 24′) and layer 30 may form some or all of a front portion for device 10 that helps separate interior 26 from exterior 28. In some embodiments, transparent layer 30 may form a single, continuous layer across the front of device 10. However, this is merely illustrative. Transparent layer 30 may be formed from individual sections, if desired.

In virtual reality arrangements, device 10 may include lenses or other optical system components and a display such as display 20 (FIG. 1) to provide virtual content to a user (e.g., still and/or moving images such as computer-generated content, etc.). In augmented reality arrangements, a forward-facing camera (e.g., a camera supported by housing 24 and/or layer 30) may gather images of the real world such as real-world object 50 for presentation to the user with display 20 and/or the user may view real-world objects such as object 50 through transparent layer 30. Waveguides with holographic couplers or other optical couplers may, as an example, overlap layer 30 and/or may be incorporated into layer 30 to merge computer-generated images from display 20 to eye boxes 36 with real-world image light (e.g., real-world image light from real-world objects such as external object 50).

Transparent layer 30 may be formed from polycarbonate, glass, plastic, or other material. To provide transparent layer 30 with the ability to pass visible light (e.g., so that a user with eyes at eye boxes 36 can view real-world images through transparent layer 30, or a display can emit light through transparent layer 30 to exterior 28), layer 30 can have bulk light transmission properties and, if desired, may have coatings (e.g., thin metal coatings and/or thin-film interference filter coatings formed from stacks of dielectric materials, and/or other coatings) that are configured to pass sufficient visible light for image viewing (e.g., at least 10% of ambient light may be transmitted, at least 50% of ambient light may be transmitted, etc.). In some configurations, layer 30 (e.g., a substrate layer of transparent polymer or other material and/or one or more coatings of dielectric, metal, thin-film interference filter coatings, etc.) may be configured to block some or all infrared light (e.g., near infrared light) and/or to transmit some or all near infrared light or other infrared light (over the entire surface of layer 30 and/or over a portion of layer 30). In arrangements in which layer 30 is transparent to infrared light, infrared optical components may operate through layer 30.

One or more components such as optical sensors 52 and light sources 53 (also referred to as light-emitting devices 53 herein) may be mounted adjacent to the inner surface of layer 30. In other words, optical sensors 52 and light sources 53 may operate through layer 30. In some embodiments one or more of optical sensors 52 and light sources 53 may form a combined sensor having a light emitter and light detector, such as a time-of-flight sensor or light detection and ranging (LIDAR) sensor. However, optical sensors 52 and light sources 53 may be independent sensors and light sources if desired.

Optical sensors 52 may include infrared cameras, time-of-flight light sensors, image sensors, depth sensors, proximity sensors, and/or other optical sensors for determining the location (e.g., the distance) of objects such as external object 50 in the user's environment (e.g., object-tracking sensors). Light sources 53 may include infrared light-emitting diodes that emit blanket infrared light, camera flashes, visible light illuminators, or other suitable light emitters.

During operation, one or more of light sources 53 may be used to emit light and/or one or more of optical sensors 52 may be used to detect light. For example, a light source 53 at a first location on the interior surface of layer 30 may emit infrared light and an optical sensor 52 at a second location on the interior surface of layer 30 may detect the infrared light. The optical sensor 52 may, as an example, detect some of the emitted infrared light that has reflected (scattered) from external object 50 (e.g., during operation of a time-of-flight sensor formed from the first and second components, during object tracking operations, and/or during other optical sensing operations).

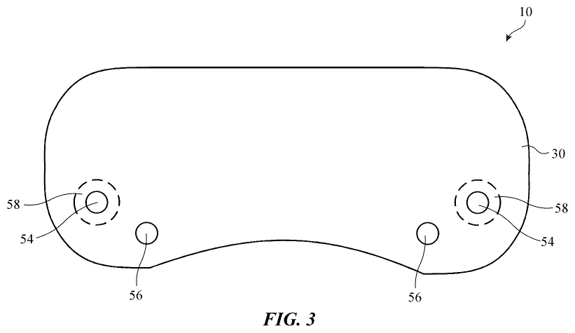

FIG. 3 is a front view of device 10 in an illustrative configuration in which device 10 includes optical components such as optical sensors 52 and light sources 53 (not shown for simplicity). The optical components may be formed in interior 26 or other suitable portion of device 10 and may be overlapped by layer 30 at one or more locations. For example, windows 54 may overlap light sources 53 and windows 56 may overlap optical sensors 52. However, the locations of windows 54 and 56 are merely illustrative. In general, there may be any suitable number of optical sensors 52 and light sources 53 in device 10 (e.g., at least one, at least two, at least three, at least four, at least 10, fewer than 25, fewer than 8, etc.). In the example of FIG. 3, there are two light-emitting components and two light-detecting components. Each light-emitting component and light-detecting component pair (e.g., that operate through adjacent windows 54 and 56) may form a corresponding object-tracking sensor or time-of-flight sensor (as examples). The emitted light from light sources 53 may be infrared light (as an example). Light sources 53 may be located at windows 54 while optical sensors 52 may be located at windows 56, or other layouts may be used.

In arrangements such as these in which emitted light from light sources 53 is being sensed by optical sensor 52, there is a potential for scattered light interference as the emitted light passes through layer 30. For example, emitted light from a light source in window 54 may scatter from an optical defect in or on layer 30 (e.g., a smudge, dust, debris, or a pit in layer 30) and this scattered light may propagate laterally within layer 30 in accordance with the principle of total internal reflection (e.g., layer 30 may serve as a waveguide). The scattered light from light source 53 at window 54 may, as an example, be detected by an optical sensor 52 at window 56. Because the scattered light did not reflect off of an external object such as object 50 (FIG. 2), but rather was coupled to the light-detecting component internally within device 10, the scattered light serves as a source of noise.

To reduce interference between light sources and optical sensors that are configured to operate through layer 30, layer 30 may include one or more stray light redirecting structures. As shown in FIG. 3, illustrative stray light redirecting structures 58 may partially or entirely surround windows 54 through which light sources 53 operate. In the example of FIG. 3, stray light redirecting structures 58 may entirely surround windows 54. However, this is merely illustrative. In general, stray light redirecting structures 58 may entirely or partially surround windows 54, may entirely or partially surround windows 56 (through which optical sensors 52 operate), or otherwise may be formed in layer 30 between windows 54 and windows 56. When structures 58 are incorporated on layer 30, stray light from light sources 53 is blocked (e.g., redirected and/or absorbed) rather than interfering with the measurements made by optical sensors 52, and may therefore improve the performance of optical sensors 52.

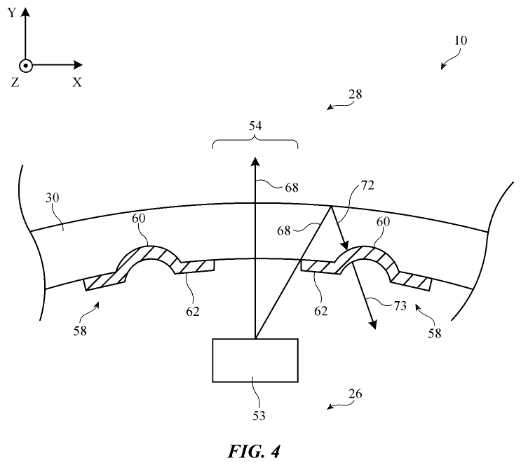

FIG. 4 is a side view of layer 30 in an illustrative configuration in which layer 30 includes a stray light redirecting structure. Layer 30 may be a transparent layer such as the transparent layer of polymer, glass, and/or other material on the front of a pair of glasses, goggles, or other head-mounted device or may be any other transparent layer for device 10. In the example of FIG. 4, stray light redirecting structure 58 is a recess (e.g., an etched portion of layer 30) formed on the inner surface of layer 30. Other stray light redirecting structures as described herein may be used, if desired.

During operation of device 10 of FIG. 4, layer 30 may allow light from light source 53 to pass from interior 26 to exterior 28 (e.g., to illuminate object 50 (FIG. 2)) and may allow light (e.g., emitted light that has been reflected from object 50) to pass from exterior 28 to interior 26 to an optical sensor (e.g., optical sensor 52 of FIG. 2)

Light-emitting device 53 emits light 68. Light 68 may be visible light, infrared light, or other light. For example, light 68 may be infrared light having a wavelength of 0.8 to 2.5 microns, from 1 micron to 2 microns, 1.5 microns, or another suitable wavelength. Some of light 68 may pass through layer 30 to exterior 28, while other light 68 may be scattered, such as by a light scattering structure on layer 30 (e.g. a surface pit or bump due to a scratch or other defect). The light may be scattered into the interior of layer 30 as stray light 72. The index of refraction of layer 30 is greater than that of the air surrounding layer 30. As a result, layer 30 serves as a light guide layer (planar waveguide) that guides stray light 72 laterally (in the X-Y plane of FIG. 4) in accordance with the principle of total internal reflection.

Due to the presence of stray light redirecting structure 58 (recess 60 in FIG. 4) a portion of stray light 72 may be directed out of layer 30 at structure 58. In other words, because recess 60 is not co-planar with the inner surface of layer 30, recess 60 may defeat the total internal reflection and allow light 72 to be redirected into interior 26 as light 73. Light 73 is then scattered and absorbed within interior 26 (such as by one or more absorptive structures within interior 26), and not detected as noise by an optical sensor.

The presence of stray light redirecting structure 58 redirects a portion (e.g., at least 30%, at least 50%, at least 70%, at least 90%, or other suitable amount) of the stray light in layer 30 that would otherwise propagate laterally within the interior of layer 30 to an optical sensor and create noise. As a result, any stray light that reaches the optical sensor is significantly reduced. The signal-to-noise ratio of the optical sensor may therefore be increased.

Opaque masking layer 62 may be formed on stray light redirecting structure 58 (recess 60), if desired. In other words, opaque masking layer 62 may partially or entirely surround window 54. Opaque masking layer 62 may be formed from ink, dye, ceramic frit, a light-absorbing polymer, a stack of thin-film dielectric layers that absorb light, or other light-absorbing material. Opaque masking layer 62 may absorb some of stray light 72, such as at least 10%, at least 20%, at least 50%, or other suitable portion of stray light 72, to further reduce the amount of stray light 72 that reaches an optical sensor. However, the inclusion of opaque masking layer 62 is merely illustrative, and opaque masking layer 62 may be omitted, if desired.

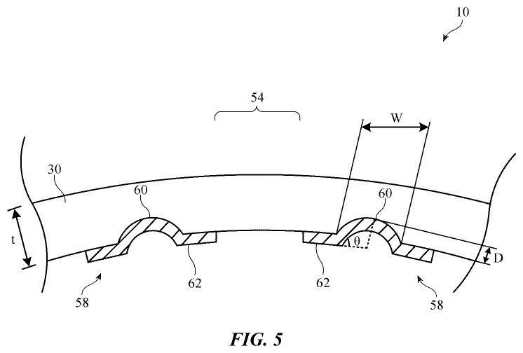

Recess 60 may have a height and shape to increase the amount of stray light rejected by recess 60. An illustrative example is shown in FIG. 5.

As shown in FIG. 5, recess 60 may have a height D (relative to an inner surface of transparent layer 30), a width W, and an initial angle (relative to the inner surface of layer 30) θ. Transparent layer 30 may have a thickness t. Thickness t may be, for example, less than 5 mm thick, less than 3 mm thick, between 1 mm thick and 1.5 mm thick, 1.4 mm thick, less than 1 mm thick, or other suitable thickness.

Height D may be at least 10% of thickness t. Therefore, height D may be at least 0.5 mm, at least 0.3 mm, or at least 0.1 mm, as examples. However, these heights of recess 60 are merely illustrative. Height D may be at least 20%, at least 40%, or at least 50% of thickness t, as examples.

Angle θ may be greater than the critical angle at which light is totally internally reflected within layer 30. The critical angle is given by Equation 1,

$$Critical Angle = arcsin ( \frac{n 2}{n 1} ) \qquad ( 1 )$$

where n2 is the material index of the air (e.g., at exterior 28) and n1 is the material index of layer 30. Index n1 of layer 30 may be, for example, between 1.5 and 2 if layer 30 is formed from polycarbonate. Index n2 of air may be approximately 1.0. Therefore, the critical angle may be between approximately 0.5 rads and 0.75 rads, and angle θ may be greater than 0.5 rads or greater than 0.75 rads, as examples.

To determine width W, the relationship of width W to angle θ may be used. In particular, the relationship between width W and angle θ is given by Equation 2

$$θ = arctan ( \frac{D}{0.5 W} ) > Critical Angle \qquad ( 2 )$$

Therefore, width W may be at least 0.18 mm, at least 0.11 mm, or at least 0.04 mm, as examples. However, these widths of recess 60 are merely illustrative. In general, width W may vary based on thickness t, height D, and the material of layer 30.

By forming recess 60 in this way, recess 60 may have a surface that is not co-planar with the inner surface of layer 30 and that is oriented so that the surface normal of recess 60 is close to parallel with rays of stray light. This locally defeats total internal reflection of the stray light within layer 30.

Stray light redirecting structures such as illustrative structure 58 of FIGS. 4 and 5 may include protrusions (e.g., ridges and/or bumps), recesses (e.g., pits or grooves), coatings (e.g., light-absorbing coatings, gratings, coatings that promote out-coupling of light by defeating total internal reflection), textured structures, and/or other structures that reduce the amount of emitted stray light that reaches optical sensors such as optical sensor 52 of FIG. 2. These protrusions and/or other structures may be formed on the inner surface of layer 30 and/or the outer surface of layer 30. Configurations in which stray light redirecting structures 58 are formed on the inner surface of layer 30 may help hide structures 58 from view by people (external viewers) in the vicinity of device 10 and may provide device 10 with a clean external appearance.

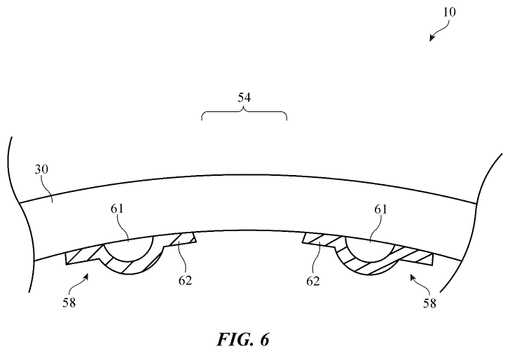

FIG. 6 is a side view of an illustrative stray light redirecting structure 58 formed from protrusion 61 on layer 30. Protrusion 61 may partially or entirely surround window 54, and may have the same height, width, and angle features as recess 60 (FIG. 5). In this way, protrusion 61 may redirect stray light that would otherwise reach an optical sensor in device 10.

Opaque masking layer 62 may optionally be provided on protrusion 61 to absorb some of the stray light and further reduce the amount of stray light that reaches the optical sensor.

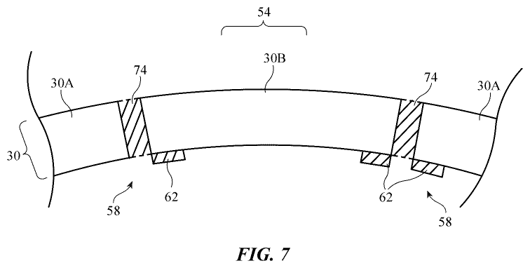

FIG. 7 is a side view of an illustrative stray light redirecting structure 58 formed from an isolated window in layer 30. In particular, layer 30 may have window 54 formed from transparent structure 30B. Transparent structure 30B may be partially or entirely surrounded by transparent structure 30A and may be separated from transparent structure 30A by gap 74. Due to the presence of gap 74 between transparent structure 30B and transparent structure 30A, stray light that is totally internally reflecting within transparent structure 30B may be redirected out of layer 30 or absorbed prior to reaching an optical sensor.

Opaque masking layer 62 may optionally be provided on an inner surface of transparent structure 30B and/or transparent structure 30A to absorb some of the stray light and further reduce the amount of stray light that reaches the optical sensor.

Gap 74 may be filled with a gasket, a polymer, or other suitable material. In some embodiments, gap 74 may be filled with a light-absorbing material that further reduces the stray light that reaches optical sensors in device 10. For example, gap 74 may be filled with the same material that is used to form opaque masking layer 62, or gap 74 may be filled with a different light-absorbing material.

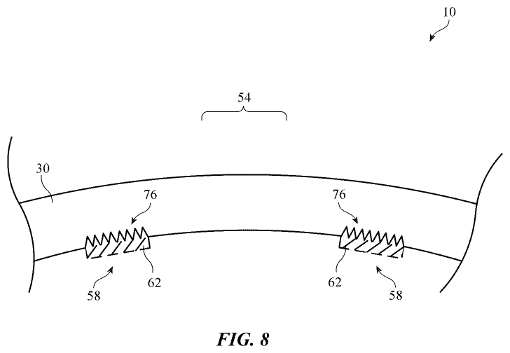

In the illustrative example of FIG. 8, stray light redirecting structure 58 is formed from light-scattering texture 76 on the surface of layer 30. Texture 76 may be formed from ridges, grooves, pits, and/or bumps with widths of less than 2 microns, 0.1-10 microns, and/or a set of one or more of these widths. The root-mean-square (RMS) surface roughness of texture 76 may be at least 0.1 microns, at least 0.2 microns, at least 0.3 microns, at least 0.5 microns, at least 0.8 microns, at least 1 micron, at least 1.5 microns, at least 2 microns, less than 2 microns, less than 3 microns, less than 5 microns, less than 0.8 microns, less than 0.6 microns, or other suitable value. Texture 76 may defeat the total internal reflection of stray light within layer 30, reducing the amount of stray light that reaches optical sensors in device 10.

Opaque masking layer 62 may optionally be provided on texture 76 to absorb some of the stray light and further reduce the amount of stray light that reaches the optical sensor.

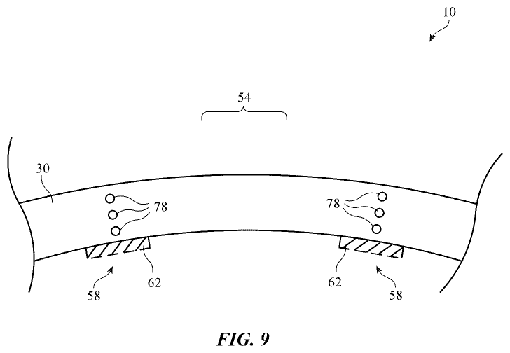

In the illustrative example of FIG. 9, stray light redirecting structure 58 is formed from micro-bubbles 78 within layer 30. Micro-bubbles 78 may be formed from locally melted portions of layer 30, and may have diameters of less than 10 microns, less than 50 microns, less than 5 microns, or other suitable diameters. In general, micro-bubbles 78 may scatter stray light in layer 30 and redirect the light out of layer 30. Therefore, micro-bubbles 78 may defeat total internal reflection of the stray light prior to the stray light reaching an optical sensor under layer 30.

Opaque masking layer 62 may optionally be provided on the inner surface of layer 30 partially or entirely surrounding window 54 (and overlapping micro-bubbles 78) to absorb some of the stray light that is scattered by micro-bubbles 78 and further reduce the amount of stray light that reaches the optical sensor.

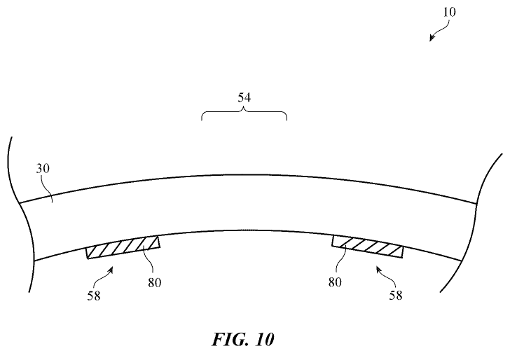

In the illustrative example of FIG. 10, stray light redirecting structure 58 is formed from a layer of material such as layer 80 that is attached to the surface of layer 30 (e.g., a planar portion of layer 30 and/or a portion with one or more protrusions and/or recesses). Layer 80 may be, for example, an index-matched polymer film. The film may be a sheet of polymer with adhesive for attaching to layer 30 and/or layer 80 may be an adhesive layer. The index-matched polymer of layer 80 may have a refractive index that matches the refractive index of layer 30 within 20%, within 5%, within 2%, or another suitable amount. Optional light-scattering structures (e.g., texture, protrusions, recesses, micro-bubbles, and/or other pattered structures of the types described in connection with FIGS. 4-9) may cover some or all of layer 80 and/or may be omitted from layer 80. Layer 80, which may sometimes be referred to as a coating, may include light-absorbing material of the type described in connection with opaque masking layer 62 (FIGS. 4-9).

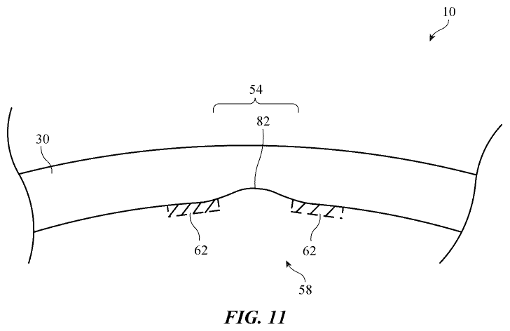

In the illustrative example of FIG. 11, rather than having a stray light redirecting structure that partially or entirely surrounds the window through which a light source emits light, the stray light redirecting structure may be within the window itself. In particular, stray light redirecting structure 58 may be formed from recess 82 (e.g., a thinned region of layer 30) that overlaps window 54 (and therefore overlaps light source 53, see FIG. 4). Recess 82 may reduce the amount of stray light that totally internally reflects within layer 30 by directing more of the light to the exterior of layer 30. If desired, recess 82 may also form a lens that focuses light emitted by the underlying light source.

Opaque masking layer 62 may optionally be provided on the inner surface of layer 30 partially or entirely surrounding window 54 to absorb some of the stray light and further reduce the amount of stray light that reaches the optical sensor.

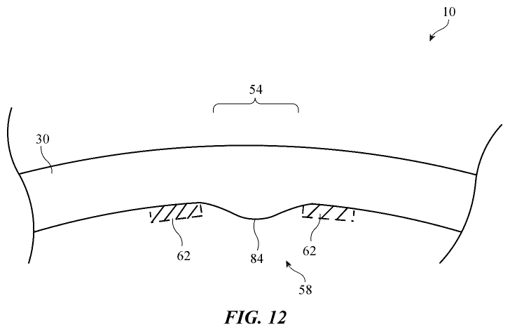

In the illustrative example of FIG. 12, stray light redirecting structure 58 may be formed from protrusion 84 (e.g., a thickened region of layer 30) that overlaps window 54 (and therefore overlaps light source 53, see FIG. 4). Protrusion 84 may reduce the amount of stray light that totally internally reflects within layer 30 by directing more of the light to the exterior of layer 30. If desired, protrusion 84 may also form a lens that focuses light emitted by the underlying light source.

Opaque masking layer 62 may optionally be provided on the inner surface of layer 30 partially or entirely surrounding window 54 to absorb some of the stray light and further reduce the amount of stray light that reaches the optical sensor.

If desired, stray light redirecting structure 58 and/or layer 30 may incorporate multiple types of material (e.g., multiple types of polymer with and/or without light-absorbing dye, pigment, etc.). As an example, layer 30 may be formed from a clear or lightly tinted rigid polymer such as polycarbonate and structure 58 may be formed from a light-absorbing polymer (e.g., polycarbonate or other polymer with light-absorbing material such as dye and/or pigment that is configured to block stray light). Structure 58 may be attached to layer 30 using heat and/or pressure and/or using adhesive bonding or other bonding techniques. If desired, structure 58 and layer 30 may be formed during polymer molding operations (e.g., layer 30 may be formed from a first shot of plastic and structure 58 may be formed from a second shot of plastic during a polymer injection molding process or other polymer molding process). Arrangements in which recesses or other features are molded into layer 30 to serve as structure 58 may also be used. If desired, laser processing, mechanical machining operations, chemical etching, lamination, coating, molding, and/or other processes may be used in forming stray light redirecting structure 58.

The types of light redirecting structures of FIGS. 4-12 may be used individually, multiple types of light redirecting structures may be incorporated into the same device, or multiple types of light redirecting structures may be incorporated between the same light source and optical sensor.

As described above, one aspect of the present technology is the gathering and use of information such as sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, interpupillary distance, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

The foregoing is illustrative and various modifications can be made to the described embodiments. The foregoing embodiments may be implemented individually or in any combination.

What is claimed is:

1. An electronic device operable in an environment with an external object, the electronic device comprising:
a transparent layer that separates an exterior region that contains the external object from an interior region;
a light source that is configured to emit light through a window in the transparent layer;
an optical sensor that is configured to detect the light after the light has reflected from the external object; and
a stray light redirecting structure on the transparent layer that blocks stray light emitted by the light source that has been coupled into an interior portion of the transparent layer, wherein the stray light redirecting structure at least partially surrounds the window.

2. The electronic device of claim 1, wherein the stray light redirecting structure comprises a recess in the transparent layer that at least partially surrounds the window.

3. The electronic device of claim 2, wherein the transparent layer has a thickness, and the recess extends into the transparent layer by a distance that is at least 10% of the thickness of the transparent layer.

4. The electronic device of claim 3, wherein the recess has an initial angle that is greater than a critical angle at which light is coupled into the transparent layer by total internal reflection.

5. The electronic device of claim 4, further comprising:
an opaque masking layer on the recess that absorbs the stray light.

6. The electronic device of claim 1, wherein the stray light redirecting structure comprises a protrusion on the transparent layer that at least partially surrounds the window.

7. The electronic device of claim 1, wherein the transparent layer comprises a first transparent structure and a second transparent structure that at least partially surrounds the first transparent structure, the stray light redirecting structure comprises a gap between the first and second transparent structures, and the window is formed in the first transparent structure.

8. The electronic device of claim 1, wherein the stray light redirecting structure comprises a textured region of the transparent layer that at least partially surrounds the window.

9. The electronic device of claim 1, wherein the stray light redirecting structure comprises micro-bubbles formed in the transparent layer.

10. The electronic device of claim 1, wherein the stray light redirecting structure comprises a polymer layer on a surface of the transparent layer, and the polymer layer has a refractive index that matches a refractive index of the transparent layer within 10%.

11. The electronic device of claim 1, wherein the transparent layer comprises a polymer layer having an exterior surface facing the exterior region and an opposing interior surface facing the interior region, the stray light redirecting structure includes a recess on the interior surface, the light is infrared light, and the optical sensor comprises an infrared camera.

12. The electronic device defined in claim 1, wherein the light source comprises an infrared light source, and the optical sensor is configured to track the external object based on the light that reflects off of the external object.

13. The electronic device of claim 1, further comprising:
an opaque masking layer on the stray light redirecting structure.

14. A head-mounted device, comprising:
a head-mounted support structure;
a transparent layer supported by the head-mounted support structure;
an optical sensor overlapped by the transparent layer; and
an infrared light source configured to emit infrared light through a window in the transparent layer, wherein the transparent layer has a stray light redirecting structure that overlaps the window and the infrared light source.

15. The head-mounted device of claim 14, wherein the stray light redirecting structure comprises a recess in the transparent layer that overlaps the window and the infrared light source.

16. The head-mounted device of claim 14, wherein the stray light redirecting structure comprises a protrusion on the transparent layer that overlaps the window and the infrared light source.

17. The head-mounted device of claim 14, wherein the stray light redirecting structure is configured to form a lens that focuses the infrared light emitted by the infrared light source.

18. The head-mounted device of claim 14, further comprising:
an opaque masking layer on the transparent layer that at least partially surrounds the window and the stray light redirecting structure.

19. A head-mounted device, comprising:
a head-mounted support structure;
a transparent layer supported by the head-mounted support structure;
an optical sensor overlapped by the transparent layer; and
an infrared light source configured to emit infrared light through a window in the transparent layer, wherein the transparent layer comprises a stray light redirecting structure that entirely surrounds the window and that is configured to direct stray light emitted by the infrared light source out of the transparent layer.

20. The head-mounted device of claim 19, wherein the stray light redirecting structure comprises a recess in the transparent layer that entirely surrounds the window.

21. The head-mounted device of claim 19, wherein the stray light redirecting structure comprises a protrusion on the transparent layer that entirely surrounds the window.
